(19) United States
(12) Patent Application Publication
(10) Pub. No.: US 2009/0224874 A1
(43) Pub. Date: Sep. 10, 2009

(54) APPARATUS, SYSTEM, AND METHOD FOR PROVIDING AUTHENTICATION AND ACTIVATION FUNCTIONS TO A COMPUTING DEVICE

(75) Inventors: Amy H. Dewar, Durham, NC (US); Nicholas E. Poore, Durham, NC (US); Robert C. Leah, Cary, NC (US)

Correspondence Address: KUNZLER & MCKENZIE, 8 EAST BROADWAY, SUITE 600, SALT LAKE CITY, UT, 84111, US

(73) Assignee: International Business Machines Corporation, Armonk, NY (US)

(21) Appl. No.: 12/042,974

(22) Filed: Mar. 5, 2008

(51) Int. Cl. G05B 19/00

(52) U.S. Cl. 340/5.53

(57) ABSTRACT

An apparatus, system, and method are disclosed for authenticating and activating access to a computing device that captures fingerprint information from a user finger and compares the captured fingerprint information to stored fingerprint information to determine an authenticating correlation. The apparatus, system, and method also sense finger motion to detect a predefined user finger action that leads to the activation of an interface or an application.

### BACKGROUND OF THE INVENTION

1. Field of the Invention

This invention relates to securing and accessing information and more particularly relates to biometric authentication and touch-screen access for information on a computing device.

2. Description of the Related Art

Much information acquires value by having restricted access. For certain kinds of information, unauthorized access can destroy its value, lead to its abuse, harm the interests of individuals, and/or infringe on the privacy of individuals. Therefore, information security is an important issue.

To protect the security of digital information, passwords are commonly employed. However, passwords are discoverable. Furthermore, individuals may have difficulty remembering a particular password, and the proliferation of multiple passwords can add a demanding layer of complexity to the access of information.

To provide greater security and ease, sensors of biometric information are also used to protect digital information. Biometric information is unique to an individual's biological makeup and, therefore, requires the presence of an authorized individual, making the information practically undiscoverable and unforgettable. One example of a biometric sensor is a fingerprint reader.

A fingerprint reader authenticates an individual to access information by reading and determining whether the unique locations of the ridges and/or valleys of skin on the individual's finger correlate to those of an individual authorized to access the information. As used herein the terms “correlate to,” “correlates to,” “correlation” and other similar expressions of the action to correlate shall mean that sufficient relationship is identified between a first set of finger print information and a reference set of finger print information. In certain embodiment, the relationship represents an exact match, in other embodiments, the correlation represents a substantial similarity, in yet other embodiments, the correlation represents such a similarity as is accepted in the art to constitute a positive identification of an individuals's finger. The fingerprint reader must be able to take readings at multiple points to determine the presence of either a ridge or a valley in the individual's skin. Touch screens powered by a capacitive system have an increased sensitivity useful in making the readings at the multiple points required to read a fingerprint.

Touch screens, powered by a capacitive system or otherwise, allow a user to alter digital information stored in a computing device coupled to a touch screen with a simple touch or set of touches. These touches may be accidental, alter the information in unintended ways, and require the computing device to consume power. To prevent the alteration of information and the consumption of power, certain devices include a power button that overrides any activity on the touch screen. However, turning off the power is a drastic solution that requires a user to wait for the device to boot.

Better solutions place a device in a state of suspension, which requires less power, pending the detection of a predefined motion on the touch screen. The predefined motion is a motion that is not likely to occur accidentally, thereby protecting information on the device from accidental alteration and preventing unnecessary power consumption. One particular device requires a predefined sliding motion to activate the device from its suspended state. However, such predefined motions do not provide security to prevent access by unauthorized individuals. To provide such security an additional layer of protection is required, such as a password.

Multiple layers of protection require multiple layers of effort by a user, reduce efficiency, and may require additional burdens, such as remembering a password. Advantages achieved by the most efficient way to provide authentication may not be combined with advantages achieved by the most efficient way to protect against accidental activation, when multiple layers are combined. Users of computing devices are highly conscious of efficiency and appreciate the combination of multiple functions in a single interaction. Additionally, users desire to increase the efficiency with which information is accessed with navigational aids.

Therefore, from the foregoing discussion, it should be apparent that a need exists for an apparatus, system, and method that can provide both authentication and activation security with a single interaction. The single interaction should be tailored for touch screens. Preferably, such an apparatus, system, and method would, in certain embodiments, include the capability within the single interaction of navigating through the information stored on the computing device.

### SUMMARY OF THE INVENTION

From the foregoing discussion, it should be apparent that a need exists for an apparatus, system, and method that combines the functionalities of authentication and activation in a single interaction. Beneficially, such an apparatus, system, and method would be tailored for a touch screen and would include in the single interaction a way to navigate towards desired information stored on a computing device.

The present invention has been developed in response to the present state of the art, and in particular, in response to the problems and needs in the art that have not yet been fully solved by currently available, distinct, solutions to the problems of authentication and activation protection for information systems. Accordingly, the present invention has been developed to provide an apparatus, system, and method for authentication and activation protection combined in a single interaction that overcomes many or all of the above-discussed shortcomings in the art.

The computer program product to authenticate and activate is provided with a plurality of modules configured to functionally execute the necessary steps of capturing fingerprint information, detecting a predefined user action, comparing the captured fingerprint information to a repository of fingerprint information sets, and unlocking an interface. These modules, in the described embodiments, include a capture module that captures fingerprint information from a user finger and a detection module that senses motion from the user finger that corresponds to a predefined user finger action. These modules also include a fingerprint analysis module that compares captured fingerprint information to fingerprint information in a repository to determining that the captured fingerprint information correlates to the stored fingerprint information. Additionally, the modules include an unlock module that activates an interface on a computing device when the predefined user finger action is detected and the captured fingerprint satisfies a correlation.

The computer program product, in one embodiment, includes an application selection module that is configured to determine a particular application on the computing device for the unlock module to activate depending on a particular predefined user finger action. In certain embodiments, the application selection module also provides particular input parameters to a particular application activated by the unlock module based on the particular predefined finger action.

A method is also presented for authenticating and activating access to information. The method includes capturing fingerprint information from a user finger, comparing the fingerprint information to at least one set of fingerprint information, and determining that the captured fingerprint information correlates to a set of fingerprint information. The method also includes sensing motion of the user finger, detecting user finger motion corresponding to at least one detectable predefined user finger action, and activating an interface providing access to a set of applications in response to detecting the predefined user finger action. In certain embodiments, the last step involves directly activating an application from the set of applications without an intervening interface.

A system of the present invention is also presented to authenticate and activate access to digital information. The system includes a computing device, with memory and a processor, a multi-point touch-sensitive screen, an authentication module, and an activation module. The authentication module allows access to a set of applications on the computing device based on fingerprint information that the authentication module captures from a user finger placed on the multi-point touch-sensitive screen. The activation module activates an application menu for the set of applications upon detecting a predefined user finger action made by the user finger on the multi-point touch-sensitive screen. In certain embodiments, the particular application menu activated depends on the particular correlation found by the authentication module for the captured fingerprint information. In further embodiments, the activation module activates a particular application from the set of applications based on a particular predefined user finger action, without activating an application menu.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an authentication and activation system in accordance with the present invention;

FIG. 2 is a schematic block diagram illustrating one embodiment of an authentication and activation computer program product in accordance with the present invention;

FIG. 3 is a schematic block diagram illustrating one embodiment of a computer program product that determines an application to activate based on a single predefined user finger action;

FIG. 4 depicts a set of predefined user finger actions comprising a continuous movement used by one embodiment of an authentication and activation in accordance with the present invention;

FIGS. 5A, 5B, and 5C depict a set of predefined user finger actions comprising distinct movements used by one embodiment of an authentication and activation system in accordance with the present invention;

FIGS. 6A and 6B depict different predefined user finger actions defined by the location of the action as used by one embodiment of an authentication and activation system in accordance with the present invention;

FIG. 7 is a schematic block diagram illustrating one embodiment of a module that determines differing application menus for activation in accordance with the present invention; and

FIG. 8 is a schematic flow chart diagram illustrating one embodiment of a method for authenticating and activating access to a computing device in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. Where a module or portions of a module are implemented in software, the software portions are stored on one or more computer readable storage media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable storage medium may take any form capable of storing machine-readable instructions on a digital processing apparatus. A computer readable storage medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

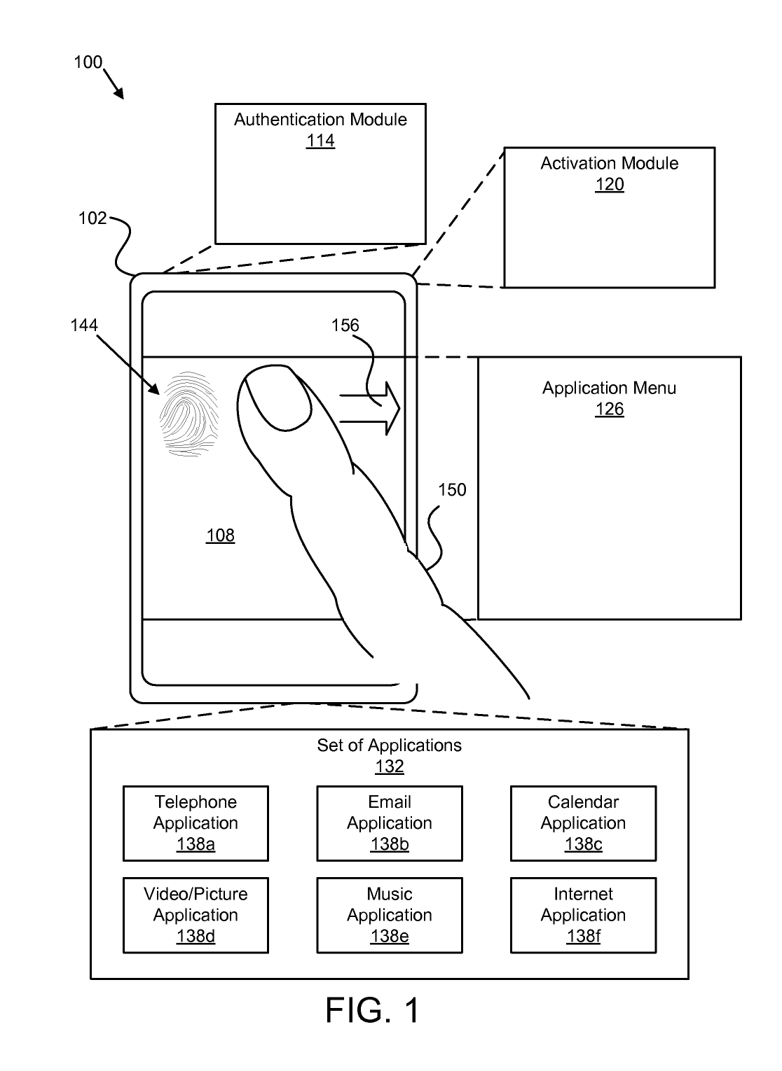

FIG. 1 depicts one embodiment of an authentication and activation system 100 in accordance with the present invention. In one embodiment, the system 100 includes a computing device 102, a multi-point touch-sensitive screen 108, an authentication module 114, and an activation module 120. As will be apparent to one of ordinary skill in the art, numerous configurations of the system 100 are possible, which, in various embodiments, may include additional modules and/or hardware. The various components of the system 100 cooperate to authenticate and activate access to an application menu 126.

The computing device 102 comprises a memory (not shown) and a processor (not shown). Depending on the embodiment, the computing device may comprise a cell phone, a personal digital assistant, a global positioning system, a laptop computer, a desktop computer, an audio/video remote control, a kiosk, a tabletop computer, or a financial transaction terminal. Other embodiments will be readily apparent to those of ordinary skill in the art in light of this disclosure.

In certain embodiments, the memory and the processor store and execute the authentication module 114, the activation module 120, the application menu 126, and a set of applications 132. The set of applications 132 includes a plurality of applications 138. In certain embodiments, the plurality of applications 138a-138f include a telephone application 138a, an email application 138b, a calendar application 138c, a video/picture application 138d, a music application 138e, and an internet application 138f. Those of ordinary skill in the relevant art will identify additional applications not listed or listed applications that are unnecessary to certain embodiments.

The authentication module 114 is coupled to the multi-point touch-sensitive screen 108. In certain embodiments, the authentication module 114 allows access to the set of applications 132 stored on the computing device 102 based on fingerprint information (not shown). In other embodiments, the set of applications 132 to which the authentication module 114 allows access only comprises certain applications 138k-138n from the set of applications stored on the computing device 102, based on the fingerprint information. The application module 114 derives the fingerprint information from a fingerprint pattern 144 on a user finger 150 sensed by the multi-point touch-sensitive screen 108.

The multi-point touch-sensitive screen 108 is coupled to the computing device 102 and is sufficiently sensitive to detect the relative location of the multiple ridges and/or valleys that occur in the fingerprint pattern 144. The authentication module 114 uses the relative location of ridges and/or valleys to generate the fingerprint information. In certain embodiments, the multi-point touch-sensitive screen 108 comprises a capacitive system. In other embodiments, the multi-point touch-sensitive screen 108 comprises a surface acoustic wave system. In additional embodiments, the multi-point touch-sensitive screen 108 comprises a resistive system. Other multi-point touch-sensitive screen systems will be apparent to those of ordinary skill in the art in light of this disclosure.

The activation module 120 is also coupled to the multi-point touch-sensitive screen 108. The activation module 120 activates an application menu 126 that may be displayed on the multi-point touch-sensitive screen 108. The application menu 126 comprises an interface that allows a user (not shown) to select an application 138n from the set of applications 132 or from a portion 138 of the set of applications 132. The activation module 120 activates the application menu 126 in response to detecting a predefined user finger action 156 from the user finger 150 through the multi-point touch-sensitive screen 108.

The predefined user finger action 156 depicted in FIG. 1 involves a sliding motion from left to right. However, in a variety of different embodiments the predefined user finger action 156 may comprise any number of motions, including a right to left motion, an downward motion, and upward motion, an up-down motion, a zig-zag motion, a swirl motion, a motion tracing a letter, a motion tracing a symbol. The motion comprising the predefined user finger action 156 may be simple or compound. Additional motions comprising the predefined user finger action 156 will be obvious to those of ordinary skill in the art in light of this disclosure.

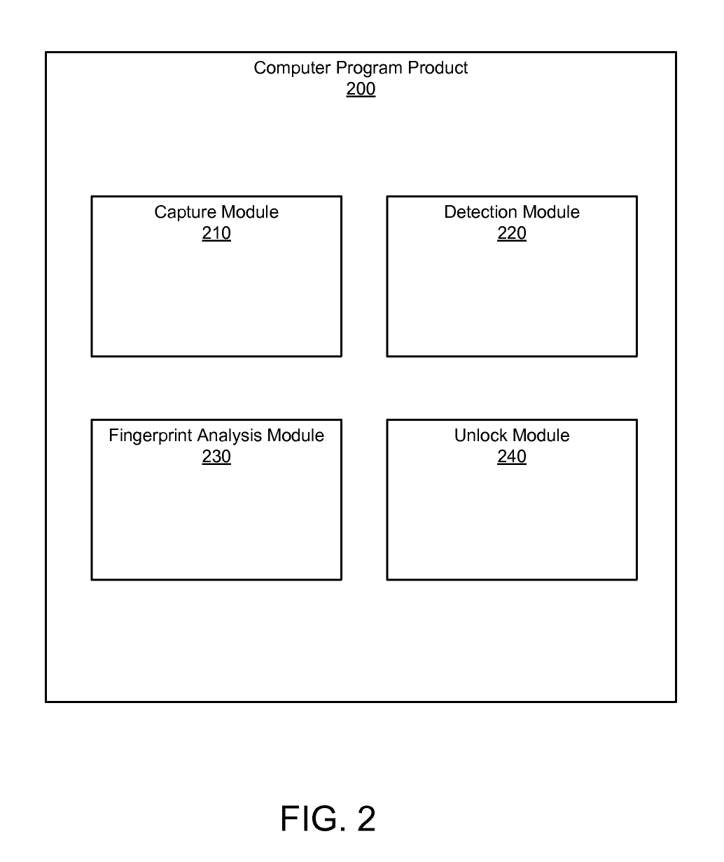

FIG. 2 depicts one embodiment of an authentication and activation computer program product 200 in accordance with the present invention. The computer program product 200 includes a capture module 210, a detection module 220, a fingerprint analysis module 230, and an unlock module 240. The components of the computer program product work together to authenticate a user (not shown) and to activate a computing device (not shown) in response to a single user motion.

The computer program product 200 includes a capture module 210. The capture module 210 captures fingerprint information (not shown) from a user finger 150 (See FIG. 1). In certain embodiments, the capture module 210 processes the fingerprint information for analysis by the fingerprint analysis module 230. In other embodiments, the capture module 210 relays the fingerprint information to the fingerprint analysis module 230 for processing.

The computer program product 200 also includes a detection module 220 that senses the motion of the user finger. The detection module 210 is configured to detect motions from the user finger corresponding to a predefined user finger action 156 (See FIG. 1). The detection module 220 is configured to detect a single predefined user finger action 156 or a plurality of different predefined user finger actions 156.

The fingerprint analysis module 230 receives fingerprint information, whether processed or unprocessed, from the capture module 210. In the event that the fingerprint analysis module 230 receives fingerprint information in unprocessed form, the fingerprint analysis module 230 processes the fingerprint information by formatting the information so as to compare the processed fingerprint information to a set of stored fingerprint information stored in a repository (not shown), such as a hard drive. In certain embodiments, the fingerprint analysis module 230 compares the processed fingerprint information to each member of the set of fingerprint information. In certain embodiments, the fingerprint information comprises the coordinates of a plurality of ridge and/or valley locations from the user finger relative to one another. After comparing the processed fingerprint information, the fingerprint analysis module 230 may determine a correlation between the processed fingerprint information and the stored fingerprint information. Depending on the correlation determined by the fingerprint analysis module 230, in various embodiments, either the fingerprint analysis module 230 or the unlock module 240, determines a set of applications (not shown), which may include all available applications or only certain applications from the available applications, that may be accessed by the user associated with the processed fingerprint information.

The computer program product 200 includes an unlock module 240. In response to the detection module 220 detecting a predefined user finger action and the fingerprint analysis module 230 determining a correlation between the captured fingerprint information and a set of fingerprint information, the unlock module 240 activates an interface (not shown) of the computing device 102. In certain embodiments, the interface is configured to allow the user (not shown) to access certain applications on the computing device 102. The interface comprises software that allows a user to interact with the computing device 102. In certain embodiments, the interface comprises an application menu. In other embodiments, the interface comprises a particular application. Additional configurations for the interface will be obvious to those of ordinary skill in the art in light of this disclosure.

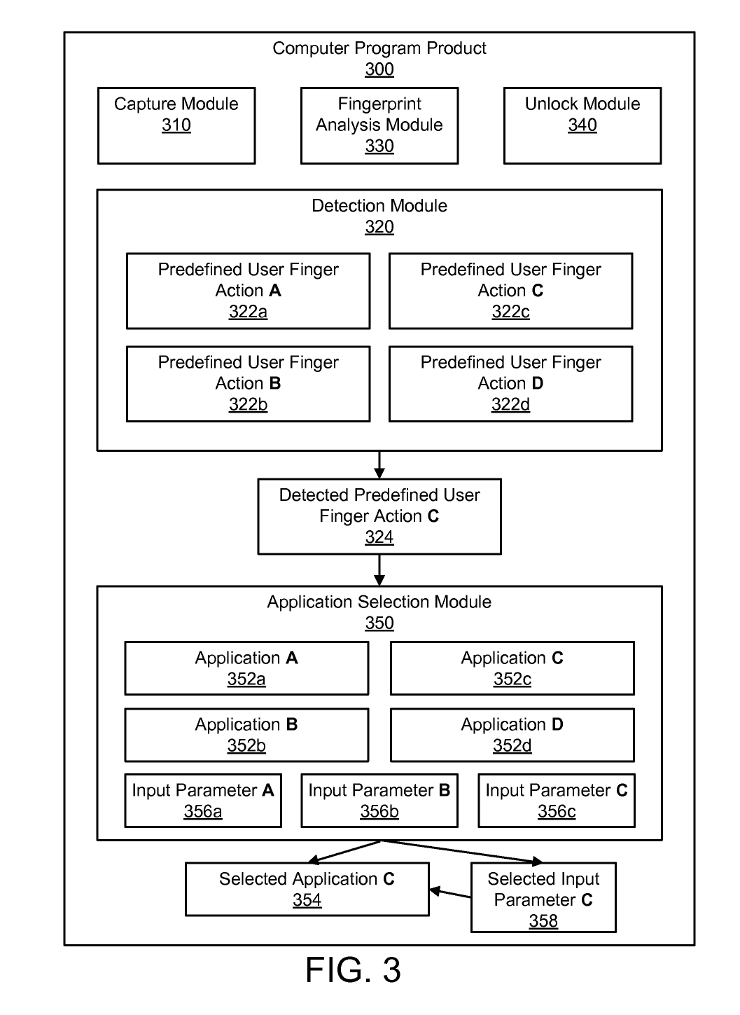

FIG. 3 depicts one embodiment of a computer program product 300 that determines a particular application for activation based on the detection of a single predefined user finger action 156 from a plurality of predefined user finger actions (not shown). The computer program product 300 includes a capture module 310, a detection module 320, a fingerprint analysis module 330, an unlock module 340, and an application selection module 350. The various components of the computer program product 300 cooperate to authenticate a user to access a selected application 354 from a plurality of applications 352a-352d on a computing device (not shown).

With respect to the computer program product 300, the capture module 310, the detection module 320, the fingerprint analysis module 330, and the unlock module 340 perform functions substantially similar to those discussed above in relation to the capture module 210, the detection module 220, the fingerprint analysis module 230, and the unlock module 240, respectively. However, the computer program product 300 also includes the application selection module 350. In certain embodiments, the application selection module 350 overrides the activation of the interface (described above) to directly activate a particular selected application 354 on the computing device 102 based on the detected user finger action 156. In other embodiments, the unlock module 340 communicates with the application selection module 350 instead of activating an interface as described above.

Before the application selection module 350 activates a selected application 354, the detection module 320 detects a particular predefined user finger action 324 from a plurality of predefined user finger actions 322a-322d detectable by the detection module 320. Each predefined user finger action 322a, 322b, 322c, 322d may correspond to a particular application 352a, 352b, 352c, 352d, as indicated to the emboldened letters “A,” “B,” “C,” and “D,” each appearing next to both a predefined user finger action 322 and an application 352. In certain embodiments, two or more predefined user finger actions correspond to the same application 352a. The number of predefined user finger actions 322 and the number of applications 352 may vary widely between embodiments. However, there will be at least one pair of a predefined user finger action 322 and an application 352.

Depending on the embodiment, the detection module 320 informs the application selection module 350 about the detected predefined user finger action 322 or the application selection module 350 makes the requisite inquiry of the detection module 320. Based on which of the predefined user finger actions 322 corresponds to the detected predefined user finger action 324, the application selection module 350 selects the corresponding application 354.

In certain embodiments, the application selection module 350 selects the application 354 with the aid of a registry (not show) of the various predefined user finger actions 322-322 and the particular applications 352-352d to which they correspond. Those of ordinary skill in the relevant art will be aware of other techniques by which the application selection module 350 may identify the selected application 354. In certain embodiments, the application selection module 350 makes an inquiry of the unlock module 340 to ensure the selected applications 354 belongs to the set of accessible applications and that the user has been authenticated for access to the selected application 354. In other embodiments, the application selection module 350 makes an inquiry of the fingerprint analysis module 330 to ensure the user has been authenticated for access to the selected application 354. In additional embodiments, either the fingerprint analysis module 330 or the unlock module 340 inform the application selection module 350 that the user is authenticated to access the selected application.

In certain embodiments, the application selection module 350 activates the selected application 354. In other embodiments, the application selection module 350 communicates with the unlock module 340, which activates the selected application 354.

In various embodiments, the application selection module 350 selects an input parameter 358 from a variety of input parameters 356a-356c. The number of potential input parameters 356a-356c varies widely depending on the embodiment. The application selection module 350 bases its selection of an input parameter 356 on the detected predefined user finger action 324. Each input parameter 356 corresponds to one or more particular predefined user finger actions 322. In certain embodiments, multiple input parameters 356 correspond to the same predefined user finger action 322n.

The application selection module 350 sends the selected input parameter 358 to the selected application 354. In certain embodiments, the application selection module 350 sends the selected input parameter 358 to the selected application 354 after the selected application 354 has been activated. In other embodiments, the application selection module 350 sends the selected input parameter 356 to the selected application 354 as part of activating the selected application 354.

The various input parameters 356 comprise data sets. These data sets may interact with various applications 322 to configure the various applications 322 in various states and/or to perform various actions. For example, in one embodiment, the selected application 354 comprises a telephone application 138a. Additionally, the selected input parameter 358 sent to the selected application 354 comprises a speed dial parameter. The speed dial parameter configures the telephone application 138a to invite a call to a particular individual set forth in the speed dial parameter. These data sets may also be processed by the various applications 322. For example, a data set may comprise a Fahrenheit temperature value for conversion to a Centigrade temperature value by a conversion application 322.

The various input parameters 356 may comprise contacts, email addresses, Uniform Resource Locators, names, queries, and any other category representable as data in data set. Many additional forms that input parameters 356 may take will be readily apparent to those of ordinary skill in the art in light of this disclosure.

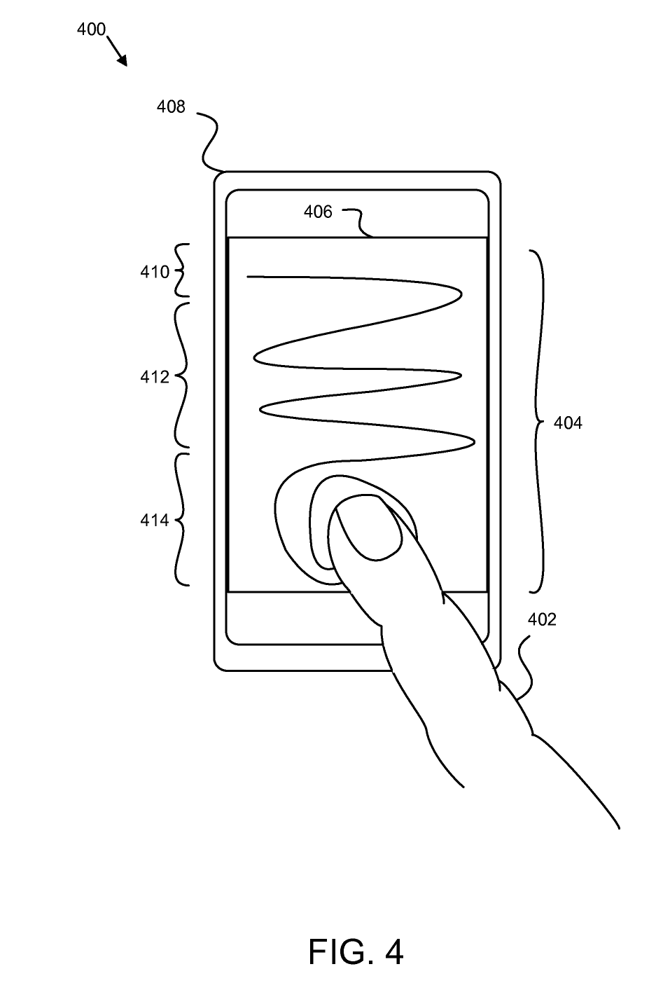

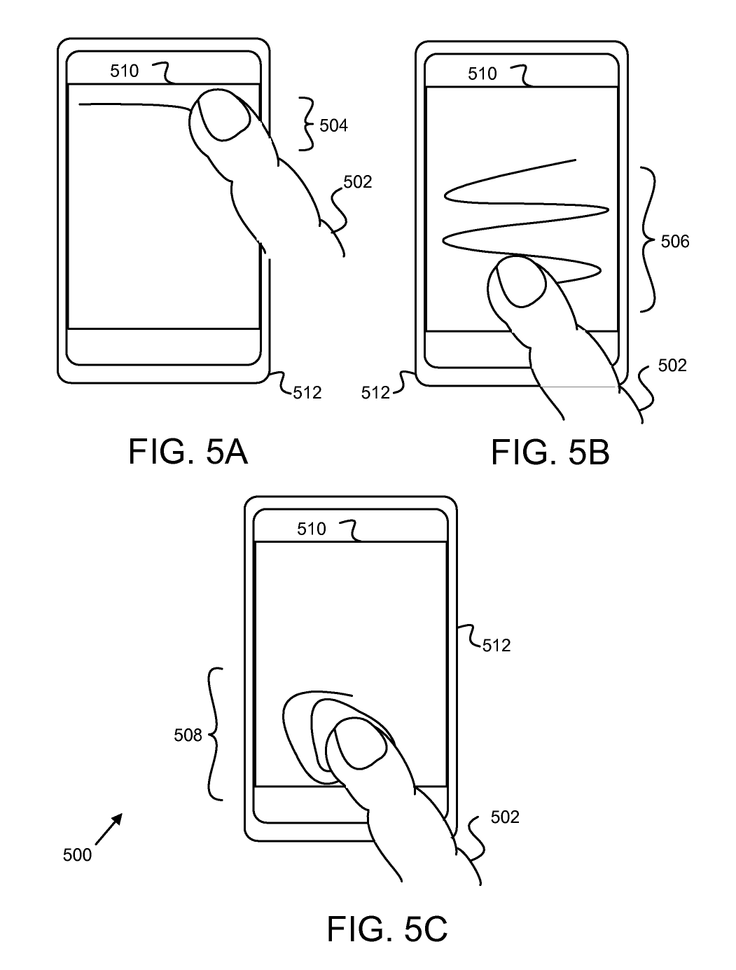

The application selection module 350, in various embodiments, requires a set of predefined user finger actions 156/322 to determine the selected application 354. Various ways in which predefined user finger actions 322 are combined to provide the application selection module 350 with the required set of predefined user finger actions are discussed below with respect to FIG. 4 and FIG. 5, comprising a set of predefined user finger actions described by a continuous movement and a set of predefined user finger actions described by distinct movements, respectively. As will be appreciated by those of skill in the relevant art, the activation module 120 discussed above with respect to FIG. 1 may be configured to perform all of the various functionalities of the application selection module 350 discussed with respect to FIG. 3.

FIG. 4 depicts a set of predefined user finger actions 400 comprising a continuous movement used by one embodiment of an authentication and activation system to determine an application for activation in accordance with the present invention. In FIG. 4, a user finger 402 performs a continuous movement 404 on a multi-point touch-sensitive screen 406 of a computing device 408. The continuous movement 404 in FIG. 4 describes a set of predefined user finger actions used by the activation module 120 of FIG. 1 or the application selection module 350 of FIG. 3 to select an application 354 for activation.

The continuous movement 404 describes multiple predefined user finger actions 410, 412, and 414 that make up the elements of the set of predefined user finger actions. In FIG. 4, the continuous motion 404 describes three predefined user finger actions 410, 412, and 414. The first predefined user finger action 410 comprises a left to right sliding motion; the second predefined user finger action 412 comprises a zig-zag motion; and, the third predefined user finger action 414 comprises a swirl motion. However, the continuous motion 404 may include any number of predefined user finger actions. Additionally, the predefined user finger actions 410, 412, and 414 may be comprised of any of the motions discussed above with respect to FIG. 1 or any motion apparent to those of ordinary skill in the relevant art.

In FIG. 4, the transitions that occur between the multiple predefined user finger actions 410, 412, and 414 that make up the continuous motion 404 are seamless. The user finger 402 does not pause between predefined user finger actions 410, 412, and 414. Rather the user finger 402 performs each predefined user finger actions 410, 412, and 414 as part of one continuous movement.

FIGS. 5A, 5B, and 5C depict a set of predefined user finger actions 500 comprising distinct movements used by one embodiment of an authentication and activation system to determine an application for activation in accordance with the present invention. FIG. 5A depicts a user finger 502 that performs a first distinct motion 504 on a multi-point touch-screen 510 of a computing device 512. The first distinct motion 504 depicted in FIG. 5A is a sliding motion from left to right comprising a predefined user finger action 156. The first distinct motion 504 may comprise any of the motions discussed above with respect to FIG. 1, or any motion apparent to those of ordinary skill in the relevant art.

FIG. 5B depicts the same user finger 502, multi-point touch-screen 510 and computing device 512 depicted in FIG. 5A. However, FIG. 5B depicts a second distinct motion 506. In FIG. 5B, the second distinct motion 506 is a zig-zag motion. However, the second distinct motion 506 may comprise any of the motions discussed above with respect to FIG. 1, or any motion apparent to those of ordinary skill in the relevant art.

Similarly, FIG. 5C depicts the same user finger 502, multi-point touch-screen 510 and computing device 512 depicted in FIG. 5A and FIG. 5B. However, FIG. 5C depicts a third distinct motion 508. In FIG. 5C, the third distinct motion 506 is a swirl motion. However, the third distinct motion 508 may comprise any of the motions discussed above with respect to FIG. 1, or any motion apparent to those of ordinary skill in the relevant art.

The first distinct motion 504, the second distinct motion 506, and the third distinct motion 508 comprise the elements of the set of predefined user finger actions required by either the activation module 120 or the application selection module 350 to select an application 352. The user finger 502 separates each of the first distinct motion 504, the second distinct motion 506, and the third distinct motion 508 with either a pause, an intervening user finger action, such as a pressure change, a change of location with respect to the multi-point touch-sensitive screen 510, and/or a removal of the user finger 502 from the multi-point touch-sensitive screen 510. The first distinct motion 504, the second distinct motion 506, and the third distinct motion 508 in FIGS. 5A, 5B, and 5C, respectively, occur in different locations with respect to the multi-point touch-sensitive screen 510. In certain embodiments, however, one or more of these distinct motions 504, 506, and 508 may occur in the same location. Additionally, in certain embodiments, the set of predefined user finger actions comprise, in terms of number, more or less than the three distinct motions 504, 506, and 508 depicted in FIGS. 5A, 5B, and 5C.

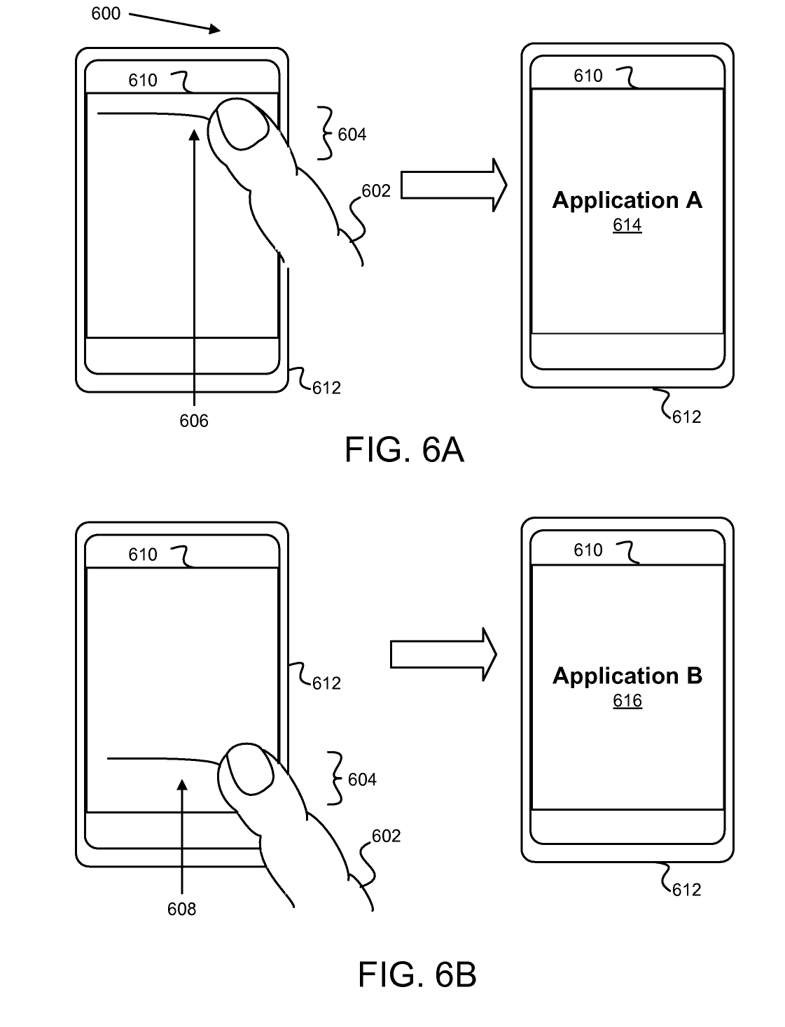

FIGS. 6A and 6B depict different predefined user finger actions 600 defined by the location of their performance as used by one embodiment of an authentication and activation system to determine applications for activation in accordance with the present invention. FIG. 6A depicts a user finger 602 that performs a distinct motion 604 on a multi-point touch-screen 610 of a computing device 612. In FIG. 6A, the user finger 602 performs the distinct motion 604 in a first location 606 defined with respect to the surface area of the multi-point touch-sensitive screen 610.

Either the first location 606 of the distinct movement or a combination of the first location 606 and the path of the distinct motion 604 describe a particular predefined user finger action 156/322 used by either the activation module 120 or the application selection module 350 discussed above to select the application 614 corresponding to the predefined user finger action 156/322 for activation. In FIG. 6A, the distinct motion 604 is a sliding motion from left to right. However, the distinct motion 604 may comprise any of the motions discussed above with respect to FIG. 1, or any motion apparent to those of ordinary skill in the relevant art. FIG. 6A depicts the application 614 pertaining to the particular predefined user finger action 156/322 described by the distinct motion 604 and the first location 606 with the application 614 appearing on the same multi-point touch-sensitive screen 610 of the computing device 612.

FIG. 6B depicts the same user finger 602 performing the distinct movement 604 depicted in FIG. 6A on the same multi-point touch-screen 610 of the same computing device 612. However, in FIG. 6B, the distinct motion 604 is performed in a second location 608, defined with respect to the surface area of the multi-point touch-sensitive screen 610. This different second location 608, either on its own or in combination with the distinct motion 604, describes a different predefined user action 156/322 from the particular predefined user finger action of FIG. 6A. Therefore, depending on the embodiment, either the activation module 120 or the application selection module 350, select a different application 616 corresponding to the different predefined user finger action 156/322 for activation. FIG. 6B depicts the different application 616 pertaining to the different predefined user finger action 156/322 activated on the same multi-point touch-sensitive screen 610 of the computing device 612.

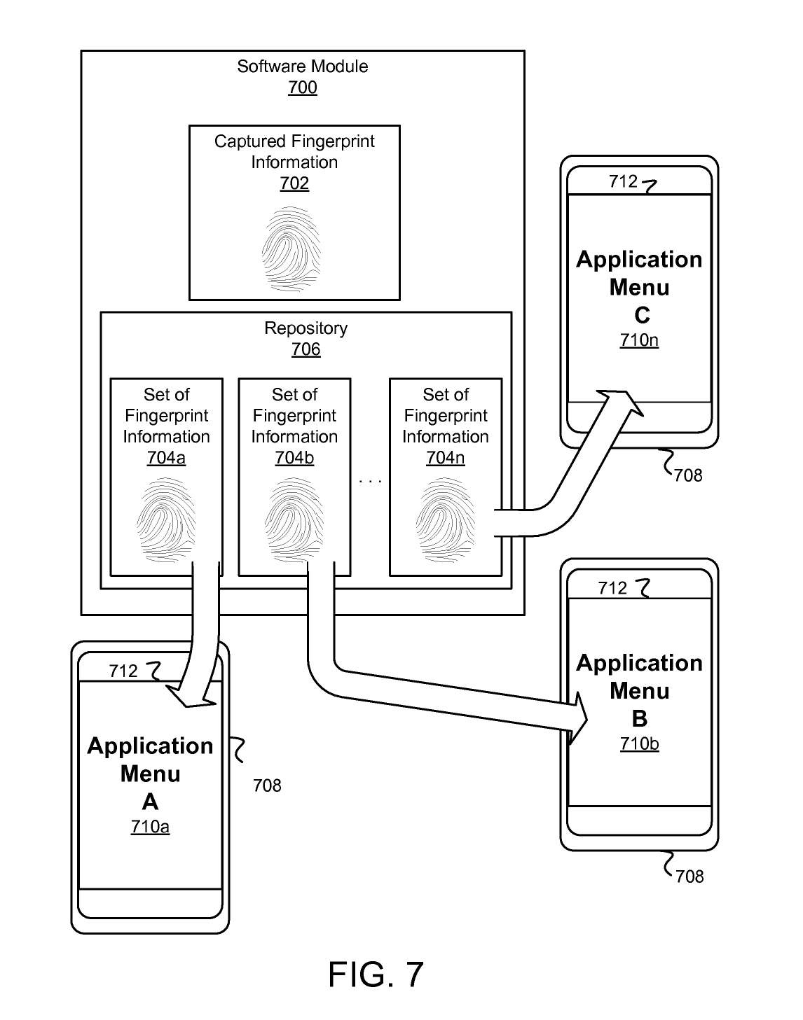

FIG. 7 is a schematic block diagram illustrating one embodiment of a software module 700 that determining different application menus 710 for activation based on a correlation between captured fingerprint information 702 and a particular set of fingerprint information 704 from a plurality of sets of fingerprint information 704 in accordance with the present invention. The software module 700 performs functions substantially similar to the fingerprint analysis module 230 described above with respect to FIG. 2. In certain embodiments, the software module 700 processes captured fingerprint information 702 into a format compatible with a plurality of sets of fingerprint information 704a-704n. Each set of fingerprint information 704 of the plurality of sets of fingerprint information 704a-704n are stored in a repository 706 on a computing device 708. In other embodiments, the software module 700 receives the captured fingerprint information 702 in a compatible format.

The software module 700 compares the captured fingerprint information 702 against the plurality of sets of fingerprint information 704a-704n until the software module 700 finds a correlation with a particular set of fingerprint information 704. The software module 700 activates a particular application menu 710 corresponding to the particular set of fingerprint information 704. In the event that the captured fingerprint information 702 does not correlate to a set of fingerprint information, no application menu 710 is activated.

Each application menu 710 is an interface that provides access to a set of applications 132 of a subset of the set of application 132 to which a user (not shown) corresponding to the captured fingerprint information 702 has been authenticated. Each application menu 710 is user specific, with specific settings, layouts, options, menus, and accessible applications 138. In certain embodiments, an application menu 710 is configurable by a user.

In certain embodiments, the software module 700 causes either the activation module 120, the unlock module 240, or the application selection module 350 to activate the particular application menu 710 corresponding to the particular set of fingerprint information 704 that correlates to the captured fingerprint information 702. The activated application menu 710 is displayed by the computing device 708 on a multi-point touch-sensitive screen 712.

In one embodiment each set of fingerprint information 704 corresponds to a family member of the owner of the embodiment. Each family member has a set of applications 132 accessible to that family member through an application menu 710 corresponding to that family member. Each application menu 710 is configured differently by each family member to the particular needs and tastes of the relevant family member and the applications 138 accessible to that family member.

The particular application menu 710 is selected for activation by the software module 700 from a plurality of application menus 710a-710n based on the correlation between the captured fingerprint information 702 and the particular set of fingerprint information 704n. Each set of fingerprint information 704 of the plurality of sets of fingerprint information 704a-704n corresponds to a particular application menu 710 of a plurality of application menus 710a-710n. In certain embodiments, multiple sets of fingerprint information 704k-704n correspond to the same application menu 710. A set of fingerprint information 704 need not correspond to any application menu 710n at all. In certain embodiments, the software module 700 maintains a registry of the plurality of sets of fingerprint information 704a-704n and their corresponding application menus 710a-710n. Other approaches to linking the plurality of sets of fingerprint information 704a-704n and their corresponding application menus 710a-710n will be readily apparent to those of ordinary skill in the relevant art in light of this application.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

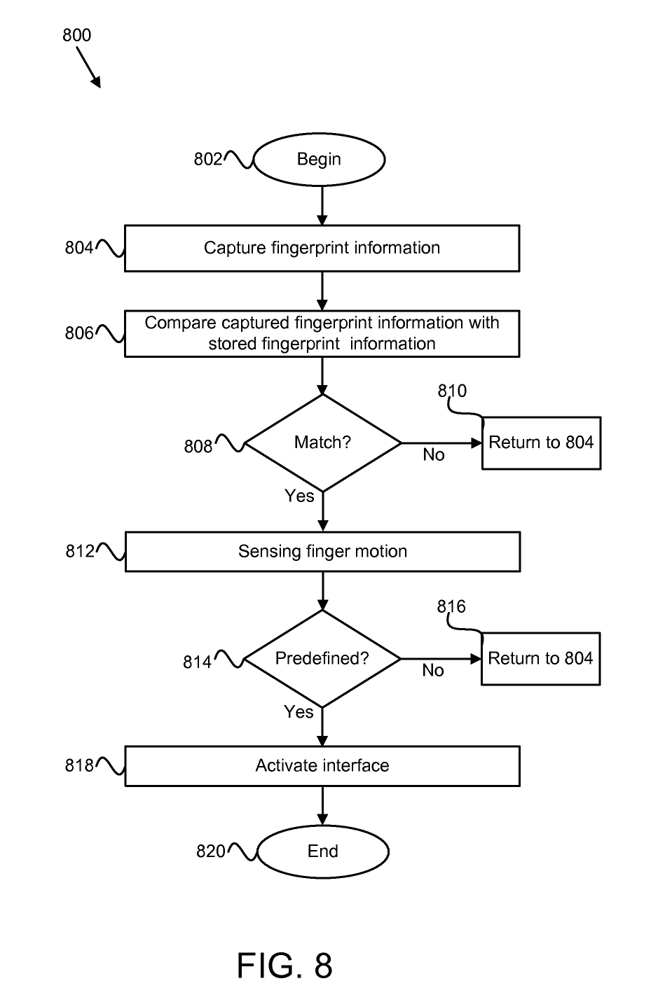

FIG. 8 is a schematic flow chart diagram illustrating one embodiment of a method 800 for authenticating and activating access to a computing device 102 in accordance with the present invention. The method 800 begins 802 and the capture module 210 captures 804 fingerprint information 702 from a user finger 156. The fingerprint analysis module 230 then compares 806 the captured fingerprint information 702 to at least one set of fingerprint information 704. The fingerprint analysis module 230 then determines 808 whether the captured fingerprint information 702 correlates to a set of fingerprint information 704 to which it is compared. In the event that the captured fingerprint information 702 does not correlate to a set of fingerprint information 704, the method 800 returns 810 to the step of capturing 804 fingerprint information.

In one embodiment, the detection module 220 senses 812 finger motion 156 from the user finger 150. The detection module 220 then detects 814 a predefined finger motion 156 in the event that the motion of the user finger 156 describes a predefined user finger action 322. Depending on the embodiment, the steps of sensing 812 and detecting 814 may directly follow or be combined with the step of capturing 804 fingerprint information. In the event that the user finger motion 156 does not describe a redefined user finger action 322, a corresponding computing device 102 is not activated and the method 800 returns 816 to the step of capturing 804 fingerprint information. In the event that the user finger motion 156 does describe a predefined user finger action 322, the unlock module 240 activates 818 an interface, which is certain embodiments is an application menu 126, and the method 800 ends 820.

In certain embodiments, the step of activating 818 an interface involves the activation of a particular application 614 by the application selection module 350 in the place of the activation of an interface 126 by the unlock module 240. In such embodiments, the application selection module 350 activates a particular application corresponding to the detected predefined user finger action 156, detected during the detection 814 step. In certain embodiments, the application selection module 350 activates a particular application corresponding to a set of predefined user finger actions 410, 412, 414/504, 506, 508 detected during the detection step 814 by the detection module 220.

Depending on the embodiment, the set of predefined user finger actions 410, 412, 414/504, 506, 508 may comprise a single continuous movement as described above with respect to FIG. 4 or distinct movements as described above with respect to FIG. 5. In additional embodiments, the predefined user finger action 156 detected during the detection step 814, whether a set of predefined user finger actions or a single predefined user finger action, is defined, in part or in whole, based on the location on a multi-point touch-sensitive screen (not shown) of the user finger motion.

In certain embodiments, the method includes an additional step of communicating a set of data by the application selection module 350 to the particular application activated. The set of data may comprise any of the input parameters 356 discussed above with respect to FIG. 3. In additional embodiments, the step of activating 818 an interface 126 is performed by the software module 700 of FIG. 7, which activates a particular application menu 710 from a plurality of application menus 710 based on a particular set of fingerprint information 704 from a plurality of sets of fingerprint information 704 may correlate to the captured fingerprint information 702. In certain embodiments, the application menu 710 is configurable by a user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable storage medium: having computer usable program code executable to perform operations to authenticate and activate access to a computing device, the computer program product comprising:
a capture module that captures fingerprint information from a user finger;
a detection module that senses motion of the user finger and detects user finger motion corresponding to at least one predefined user finger action;
a fingerprint analysis module that compares the fingerprint information captured by the detection module to at least one set of fingerprint information stored in a repository, the fingerprint analysis module determining that the captured fingerprint information correlates to a set of fingerprint information from the at least one set of fingerprint information; and
an unlock module that activates an interface of a computing device in response to the detection module detecting a predefined user finger action of the at least one predefined user finger action and the fingerprint analysis module determining a correlation between the captured fingerprint information and the set of fingerprint information from the at least one set of fingerprint information stored in the repository.

2. The computer program product of claim 1, further comprising an application selection module that determines an application from a set of applications for the unlock module to activate based on a predefined user finger action defined within a plurality of predefined user finger actions that comprise the at least one predefined user finger action, the single predefined user finger action detected by the detection module.

3. The computer program product of claim 2, wherein the application selection module determines an application from the set of applications for the unlock module to activate based on a set of predefined user finger actions from the plurality of predefined user finger actions, the set of predefined user finger actions detected by the detection module.

4. The computer program product of claim 3, wherein the set of predefined user finger actions comprises one continues movement.

5. The computer program product of claim 3, wherein the set of predefined user finger actions comprises distinct movements.

6. The computer program product of claim 2, wherein the application selection module determines an application from the set of applications for the unlock module to activate based on a location of the predefined user finger action defined with respect to a multi-point touch-sensitive screen.

7. The computer program product of claim 2, wherein the application selection module sends an input parameter to the application activated by the unlock module, the input parameter determined by the predefined user finger action.

8. The computer program product of claim 1, wherein the at least one predefined action comprises a sliding motion by the user finger on a multi-point touch-sensitive screen.

9. A method for authenticating and activating an application of a computing device, the method comprising:
capturing fingerprint information from a user finger;
comparing the fingerprint information to at least one set of fingerprint information;
determining that the captured fingerprint information correlates to a set of fingerprint information from the at least one set of fingerprint information;
sensing motion of the user finger;
detecting user finger motion corresponding to at least one detectable predefined user finger action; and
activating an interface in response to detecting a user finger motion corresponding to at least one detectable predefined user finger action.

10. The method of claim 9, wherein activating comprises activating a particular application from a set of applications based on a detected predefined user finger action from a plurality of detectable predefined user finger actions that comprise the at least one detectable predefined user finger action.

11. The method of claim 10, further comprising activating the particular application together with at least one parameter.

12. The method of claim 9, wherein activating comprises directly activating a particular application from a set of applications based on a set of detected predefined user finger actions from the plurality of detectable predefined user finger actions.

13. The method of claim 12, wherein the set of predefined user finger actions comprises one or more members selected from the group consisting of one continues movement by the user finger and distinct movements by the user finger.

14. The method of claim 9, wherein activating comprises directly activating a particular application from a set of applications based on a location on a multi-point touch-sensitive screen of the detected predefined user finger action.

15. The method of claim 9, wherein the interface comprises a particular user-specific application menu from a set of user-specific application menus, each user-specific application menu being configurable by a user, the particular user-specific application menu determined by the correlating set of fingerprint information.

16. A system to authenticate and activate access to a computing device with a touch screen display, the system comprising:
a computing device comprising a memory and a processor;
a multi-point touch-sensitive screen coupled to the computing device;
an authentication module coupled to the multi-point touch-sensitive screen that allows access to a set of applications on the computing device based on fingerprint information that the authentication module captures from a user finger placed on the multi-point touch-sensitive screen; and
an activation module that activates an application menu that accesses the set of applications based on a predefined user finger action made by the user finger on the multi-point touch-sensitive screen.

17. The system of claim 16, wherein the activation module directly activates a particular application from the set of applications based on a particular predefined user finger action from a plurality of predefined user finger actions detectable by the activation module, the particular predefined user finger action made by the user finger on the multi-point touch-sensitive screen.

18. The system of claim 16, wherein the activation module directly activates a particular application from the set of applications based on a set of predefined user finger actions detected by the activation module.

19. The system of claim 18, wherein the set of predefined user finger actions comprises one continues movement.

20. The system of claim 18, wherein the set of predefined user finger actions comprises distinct movements.

21. The system of claim 16, wherein the activation module directly activates a particular application from the set of applications based on a location of the user finger action with respect to the multi-point touch-sensitive screen.

22. The system of claim 16, wherein the activation module sends a speed dial parameter to a telephone application activated by the activation module based on the particular predefined user finger action.

23. The system of claim 16, wherein the activation menu associates with a particular set of fingerprint information from a plurality of sets of fingerprint information in the at least one set of fingerprint information.

24. The system of claim 16, wherein the multi-point touch-sensitive screen comprises a capacitive sensor.

25. The system of claim 16, wherein the computing device is a device selected from the group consisting of a cell phone, a personal digital assistant, a global positioning system, a laptop, a desktop computer, a kiosk, a tabletop computer, and a financial transaction terminal.
